(19) United States
(12) Patent Application Publication
(10) Pub. No.: US 2017/0111424 A1
(43) Pub. Date: Apr. 20, 2017

(54) A METHOD AND APPARATUS FOR REPORTING DATA FROM A WIRELESS DEVICE TO A NETWORK NODE OF A COMMUNICATION NETWORK

(71) Applicant: TELEFONAKTIEBOLAGET LM ERICSSON (PUBL), Srockholm (SE)

(72) Inventor: Hongxia Long, Kunshan (CN)

(73) Assignee: TELEFONAKTIEBOLAGET LM ERICSSON (PUBL), Stockholm (SE)

(21) Appl. No.: 15/117,614

(22) PCT Filed: Jul. 8, 2015
(86) PCT No.: PCT/CN2015/083557

§ 371 Date: Aug. 9, 2016

(51) Int. Cl. H04L 29/06

(52) U.S. Cl. CPC H04L 65/80; H04L 65/4076; H04L 67/02

(57) ABSTRACT

A method executable in a wireless device, comprising a MBMS client and a non-MBMS client, for reporting QoE from the wireless device to a second network node of a wireless network, is suggested. The method comprise: receiving, from a first network node, a message indicating that QoE reporting from the MBMS client shall be coordinated with QoE reporting from the non-MBMS client; determining, by the MBMS client, whether or not the MBMS client is to establish coordinated QoE reports to the second network node; coordinating, between the MBMS client and the non-MBMS client, a coordinated QoE reporting configuration, at least partly on the basis of the result of said determining; determining, by the non-MBMS client, on the basis of content of said configuration, whether or not the non-MBMS client is to establish coordinated QoE reports to the second network node, and transmitting any established, coordinated QoE report to the second network node.

### TECHNICAL FIELD

The present disclosure relates to methods and arrangements for requesting, reporting, and using Quality of Experience (QoE) from a wireless device to a network node of a wireless communication network.

### BACKGROUND

Dynamic Adaptive Streaming over HTTP (DASH) based multimedia presentations and segments can be delivered over evolved Multimedia Broadcast Multicast Services (eMBMS) Point-to-Multipoint (P2M) bearers, by applying a process, typically referred to as DASH-over-eMBMS. This is one way of integrating two promising technologies, in order to bring the best out of both technologies. By using the P2M bearer as the transport layer, the radio network efficiency can be improved quite a lot in scenarios where popular content is consumed by mass audiences at the same time on pre-planned locations, compared to instead having to deliver the same content multiple times by unicast via Point-to-Point (P2P) bearers. By using DASH as the application layer, content can be prepared once, typically with multi-variant versions, and can also be delivered by different access methods, such as e.g. via hybrid networks. If within eMBMS coverage in the latter scenario, one high quality version is delivered, wherein if a client is out of eMBMS coverage, that client will be able to adaptively get the best variant version based on instant network performance.

FIG. 1 is a simplified overview of a network system 100, comprising a DASH encoder and formatter 110, capable of providing media segments to a BM-SC multicast delivery function 120. The BM-SC multicast delivery function 120 is configured to deliver a User Service Description (USD) and associated broadcast segments over File Delivery over Unidirectional Transport (FLUTE) to wireless devices, here represented by wireless device 130, via an interface, as defined e.g. in chapter 5 and 7 of 3GPP TS 26.346 R13 v.13.1.0. In the present example, the wireless device 130 comprises a separate DASH client 140 and a MBMS client 150. In order to measure the Quality of Experience (QoE) during consumption of DASH-Over-eMBMS services, chapter 8 and 9 of 3GPP TS 26.346 R13 v13.1.0 defines specific reception reporting procedures for a MBMS client to report the specific QoE metrics as one post Associate Delivery Procedure (ADP). In order to prevent overloading of a BM-SC MBMS reception reporting server, here represented by BM-SC MBMS reception reporting server 160, when servicing mass audiences, there are some configurations and mechanisms defined which includes a random selection of the server from a list of available servers. In sub-clause 9.4.3 of 3GPP TS 26.346 R13 v13.1.0 a sample percentage attribute is described, which allows an MBMS client to apply sample based statistical reporting, by using a random number generator (not shown) with a given percentage as input, to find out if the MBMS client is to report or not, after having measured relevant metrics at the transport layer, and subsequent to Forward Error Correction (FEC) decoding, if applicable. Applicable QoE metrics are also mentioned in Sub-clause 8.4 of the 3GPP spec. mentioned above.

The MPEG-DASH specification ISO/IEC 23009-1:2014(E) defines a Media Presentation Description (MPD) format for reporting QoE metrics from the DASH client 140 to a DASH reception report server 170. 3GPP DASH specification TS 26.247 R13 v13.0.0, sub-clause 10.2 also mentions a methodology and a listing of QoE metrics to be collected and reported by the DASH client 140. From the different listings it is obvious that different metrics are reported by the different procedures mentioned above.

Also the DASH client 140 is using a random number generator (not shown) with a given percentage, to find out if the DASH client 140 shall report or not. Compared to the MBMS QoE configuration, there is only one reporting server attribute allowed to be defined for the DASH client 140, instead of a list of available servers. When any of the two clients 140;150 reports to the respective server, a Client Identity (client ID) shall be included in the report, in order to identify the user, usually by the Mobile Station International Subscriber Directory Number (MSISDN). Chapter 9.4.6 of 3GPP TS 26.346 R13 v13.1.0 also defines a device identity (device ID) attribute, typically the International Mobile Equipment Identity (IMEI), thereby enabling also specific identification of the consumer device, represented by wireless device 130, and used by the identified user. Thereby post processing of reception reporting data can be more precise, e.g. in situations when multiple consumer devices, or wireless devices, are being used by the same user or subscriber. As indicated above, with reference to FIG. 1, the two clients 140;150 are delivering separate, independent QoE reports, according to separate procedures to the network side 160;170.

### SUMMARY

It is an object of the present document to address, or at least alleviate, at least some of the problems described above. More specifically, it is an object of the present document to disclose methods for enabling coordination of QoE reports and to provide arrangements which are capable of executing the suggested methods,

According to one aspect, a method to be executed in a wireless device, comprising a MBMS client and a non-MBMS client, is suggested for reporting QoE from the wireless device to a second network node of a wireless network, The suggested method comprise: receiving a message from a first network node, where the received message is indicating that QoE reporting from the MBMS client shall be coordinated with QoE reporting from the non-MBMS client; determining, by the MBMS client, whether or not the MBMS client is to establish coordinated QoE reports to the second network node; coordinating a coordinated QoE reporting configuration between the MBMS client and the non-MBMS client, at least partly on the basis of the result of the executed determining procedure, and determining, by the non-MBMS client, on the basis of content of the performed configuration, whether or not the non-MBMS client is to establish coordinated QoE reports to the second network node, and transmitting any established, coordinated QoE report to the second network node.

By applying the suggested method, a network node, obtaining coordinated QoE reports, will later be able to process related reports and make decisions on how to optimize the network, based on the coordinated reports. Coordination of QoE reporting may e.g. comprise coordination of a first set of metrics of a first protocol layer, measured by the MBMS client and second set of metrics of a second protocol layer, measured by the non-MBMS client.

According to another aspect, a computer program for a wireless device which device is comprising a MBMS client and a non-MBMS client, for reporting QoE from the wireless device to a second network node of a wireless network, is suggested, where the computer program comprises computer program code, which, when executed by at least one processor of the wireless device causes the wireless device to perform the above mentioned method.

According to yet another aspect, a computer program product, comprising a computer program as disclosed above and a computer readable means, on which the computer program is stored, is suggested.

According to another aspect, a wireless device capable of executing the method described above is suggested, where this wireless device comprises means for: receiving, a message from a first network node, where the message is indicating that QoE reporting from the MBMS client shall be coordinated with QoE reporting from the non-MBMS client; determining, by the MBMS client, whether or not the MBMS client is to establish coordinated QoE reports to the second network node; coordinating a coordinated QoE reporting configuration, between the MBMS client and the non-MBMS client, at least partly on the basis of the result of said determining process, and determining, by the non-MBMS client, on the basis of content of the executed configuration, whether or not the non-MBMS client is to establish coordinated QoE reports to the second network node, and transmitting any established, coordinated QoE report to the second network node.

According to yet another aspect, a wireless device, comprising a MBMS client and a non-MBMS client, for reporting QoE from the wireless device to a second network node of a wireless network, is suggested. The wireless device further comprise a processor and a memory, where the memory comprise instructions which when executed by the processor causes the wireless device to: receive a message, from a first network node, where the message is indicating that QoE reporting from the MBMS client shall be coordinated with QoE reporting from the non-MBMS client; determine, by the MBMS client, whether or not the MBMS client is to establish coordinated QoE reports to the second network node; coordinate a coordinated QoE reporting configuration, between the MBMS client and the non-MBMS client, at least partly on the basis of the result of said determining; determine, by the non-MBMS client, on the basis of content of said configuration, whether or not the non-MBMS client is to establish coordinated QoE reports to the second network node, and transmit any established, coordinated QoE report to the second network node.

According to another aspect, a method in a network node for requesting QoE reporting from a wireless device, comprising a MBMS client and a non-MBMS client, is suggested, where the method comprise: determining that a QoE report which is coordinated between the two clients is required; generating a message, comprising an indicator, indicating the requirement of the coordinated QoE reporting, and transmitting the generated message to the wireless device.

By applying the method suggested above, the network will be able to apply coordinated QoE reporting only when required, while any type of conventional reporting may instead be applied when no coordinated reporting is required.

According to yet another aspect a computer program for a network node, comprising a MBMS client and a non-MBMS client, for reporting QoE from the wireless device to a second network node of a wireless network is suggested, where the computer program comprises computer program code, which, when executed by at least one processor of the network node causes the network node to perform the method described above.

According to another aspect a computer program product, comprising a computer program as disclosed above and a computer readable means on which the computer program is stored, is suggested.

According to another aspect a network node for requesting QoE reporting from a wireless device, comprising a MBMS client and a non-MBMS client, as described above, is suggested, where the network node comprise means for: determining that a QoE report that is coordinated between the two clients is required; generating a message comprising an indicator, indicating the requirement of the coordinated QoE reporting, and transmitting the generated message to the wireless device.

According to yet another aspect, a network node for requesting QoE reporting from a wireless device, comprising a MBMS client and a non-MBMS client, is suggested, where the network node comprise a processor and a memory, where the memory comprise instructions, which when executed by the processor causes the network node to: determine that a QoE report that is coordinated between the two clients is required; generate a message comprising an indicator, indicating the requirement of the coordinated QoE reporting, and transmit the generated message to the wireless device.

According to another aspect, a method in a network node of a wireless network for processing content of QoE reports reported from wireless devices, each comprising a MBMS client and a non-MBMS client, is suggested, where the method comprise: receiving a coordinated QoE report from one of the wireless devices; correlating the received coordinated QoE report with previously received coordinated QoE reports; determining, on the basis of the executed correlating, if at least one action is required by the network node, and initiating the at least one action, in case it is determined that this is required.

According to yet another aspect, a computer program for a network node, comprising a MBMS client and a non-MBMS client, for reporting QoE from the wireless device to a second network node of a wireless network, is suggested, where the computer program comprise computer program code, which, when executed by at least one processor of the network node causes the network node to perform the method as disclosed above.

According to another aspect, a computer program product, comprising a computer program as suggested above and a computer readable means, on which the computer program is stored, is suggested.

According to another aspect, a network node of a wireless network for processing content of QoE reports reported from wireless devices, each comprising a MBMS client and a non-MBMS client, is suggested, where the network node comprises means for: receiving at least one coordinated QoE report from one of the wireless devices; correlating the at least one received coordinated QoE report with previously received coordinated QoE reports; determining, on the basis of the correlating process, if at least one action is required by the network, and initiating the at least one action, in case it is determined that this is required.

According to another aspect, a network node of a wireless network for processing content of QoE reports reported from wireless devices, each of which is comprising a MBMS client and a non-MBMS client, is suggested, where the network node is comprising a processor and a memory, where the memory comprise instructions, which when executed by the processor causes the network node to: receive at least one coordinated QoE report from one of the wireless devices; correlate the at least one received coordinated QoE report with previously received coordinated QoE reports; determine, on the basis of the executed correlating, if at least one action is required by the network node, and initiate the at least one action, in case it is determined that this is required.

### BRIEF DESCRIPTION OF DRAWINGS

Embodiments will now be described in more detail in relation to the accompanying drawings, in which:

FIG. 1 is a simplified overview of a MBMS enabled network and a MBMS enabled wireless device.

FIG. 2 is a signalling scheme, illustrating a procedure for a network node of an MBMS network to request coordinated QoE reporting from an MBMS enabled wireless device.

FIG. 3 is another signalling scheme, illustrating a procedure for enabling coordinated QoE reporting from a wireless device, according to one embodiment.

FIG. 4 is yet another signalling scheme, illustrating a procedure for enabling coordinated QoE reporting from wireless devices, according to another embodiment.

FIG. 5 is a signalling scheme, illustrating a procedure for making use of coordinated QoE reports received from wireless devices.

FIG. 6 is a flow chart, illustrating a method, executable in a wireless device for enabling the wireless device to apply coordinated QoE reporting.

FIG. 7 is another flow chart, illustrating a method executable in a network node, for requesting a wireless device to apply coordinated QoE reporting.

FIG. 8 is yet another flow chart, illustrating a method, executable in a network node, for making use of coordinated QoE reports.

FIG. 9 is a block scheme, illustrating a wireless device according to a first embodiment.

FIG. 10 is another block scheme, illustrating a wireless device according to a second embodiment.

FIG. 11 is a block scheme, illustrating a BM-SC according to a first embodiment.

FIG. 12 is a block scheme, illustrating a BM-SC according to a second embodiment.

FIG. 13 is a block scheme, illustrating a Managing Node according to a first embodiment.

FIG. 14 is a block scheme, illustrating a Managing Node according to a second embodiment.

### DETAILED DESCRIPTION

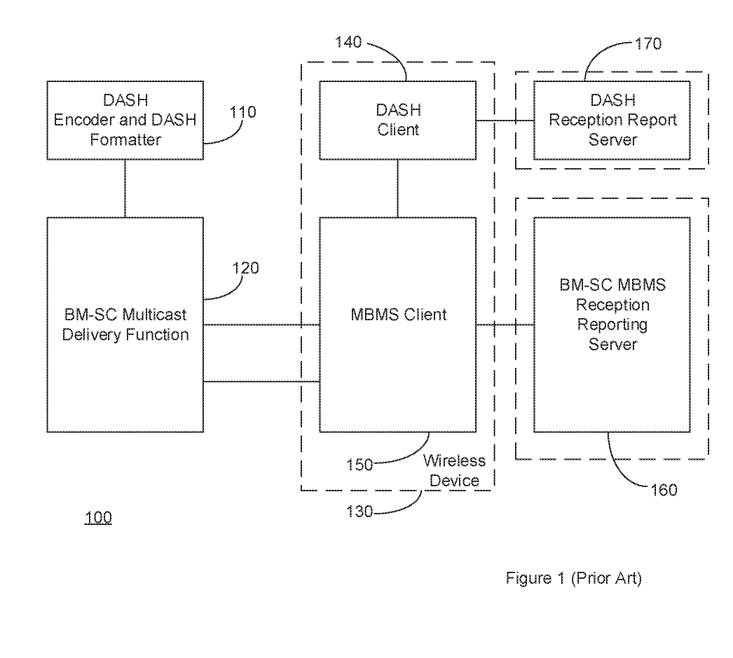

Briefly described, a method to be executed in association with QoE reporting from a wireless device, comprising two types of clients, e.g. as described previously, with reference to FIG. 1, to a network node of a wireless network, typically referred to as a reception report server, is suggested. It is to be understood that FIG. 1 is showing a simplified overview, where nodes and functional entities not necessary for understanding the general principles of the suggested invention have been omitted for simplicity reasons. More specifically, the suggested method enables a network node, requesting for QoE reporting, to request the two clients to coordinate their QoE reporting, so that reports provided from the two clients can later be identified at the network side as originating from the same wireless device. The suggested method also enables the two clients to provide coordinated QoE reports to the same reception report server, rather than to two different servers, thereby also obtaining a better balancing of workload between network nodes, e.g. reception report servers, to report to.

In addition, by coordinating the reporting, the server receiving the report, or any network node making use of such a report, will be able to make use of data relevant for both clients at one single occasion, thereby enabling for better decisions to be taken in the network on the basis of the content of the reports provided from the wireless device. Rather than making independent, un-coordinated decisions on QoE reporting, resulting in reports which will be very difficult to combine, the suggested method will provide for coordinated decisions to be taken on the network side.

By enabling also DASH QoE metrics to be reported together with a device ID, coordination is improved also in situations when only the DASH client is providing QoE reports.

Even though the suggested method is very suitable for a wireless device, comprising a MBMS client and a DASH client, the suggested methods may also be applicable for wireless devices where co-ordination of a MBMS client and any other non-MBMS client, such as e.g. a HTTP Live Streaming(HLS) is instead required.

It is also to be understood that, although the given examples are referring to MBMS, the suggested methods are applicable also for evolved MBMS (eMBMS).

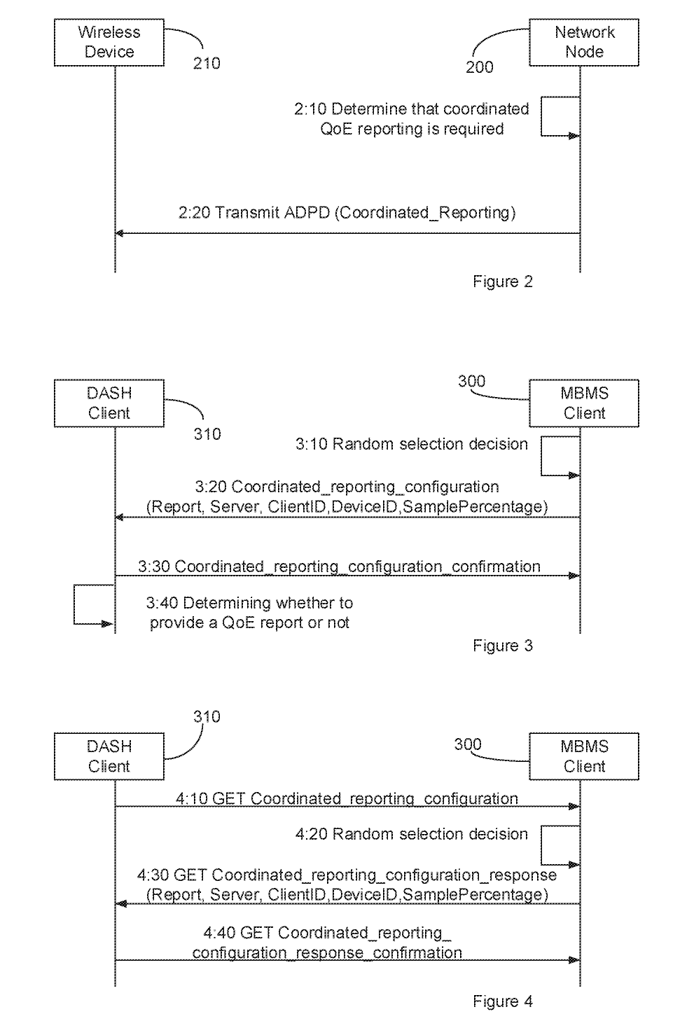

FIG. 2 is a signalling scheme illustrating how the suggested method can be initiated at a network node of a MBMS network. As indicated in FIG. 2, a network node 200, which is typically a BM-SC or any other network node, comprising corresponding multicast delivery functionality, is determining that coordinated QoE reporting is to be applied by a specific wireless device 210, as indicated with a first step 2:10. The term wireless device is herein to be referred to as meaning any type of MBMS enabled portable or fixed mounted device, which may also be referred to as mobile communication terminal, user equipment, mobile terminal, machine-to-machine (M2M) device, and may e.g. be a mobile phone, or a tablet/laptop with wireless connectivity.

In order to allow the network node 200 to instruct the wireless device 210 of the required coordinated QoE reporting an updated signalling scheme is suggested, where, according to one embodiment, the current Associated Delivery Procedure Description (ADPD) is extended with an attribute, where the new attribute, if enabled, i.e. set to “true”, will indicate that coordinated QoE reporting is required, while a disabled attribute, set to “false”, will signal that no coordinated QoE reporting is required, i.e. that un-coordinated, independent reporting, according to prior art procedures, is required from the two clients of a wireless device. The extended ADPD is transmitted to the wireless device 210 in step 2:20.

When applying the new attribute, the new ADPD may be described as follows, where the attribute in the given example has been denoted “integratedDashOverMbmsReporting” and underlined:

<?xml version=“1.0” encoding=“UTF-8”?>
<xs:schema

xmlns=“urn:3gpp:metadata:2005:MBMS:associatedProcedure”
xmlns:xs=http://www.w3.org/2001/XMLSchema
xmlns:r12=“urn:3gpp:metadata:2005:MBMS:associatedProcedure-rel-12-

| | |
|---|---|
| extension” | xmlns:sv=“urn:3gpp:metadata:2009:MBMS:schemaVersion” |

targetNamespace=“urn:3gpp:metadata:2005:MBMS:associatedProcedure”
elementFormDefault=“qualified”>
version=“1”>
<xs:import namespace=“urn:3gpp:metadata:2009:MBMS:schemaVersion”

schemaLocation=“schema-version.xsd”/>

<xs:import

namespace=“urn:3gpp:metadata:2005:MBMS:associatedProcedure-rel-12-
extension” schemaLocation=“adpd-rel-12-extension.xsd”/>

<xs:element name=“associatedProcedureDescription”

type=“associatedProcedureType”/>

<xs:complexType name=“associatedProcedureType”>

<xs:sequence>

<xs:element name=“postFileRepair” type=“basicProcedureType”

minOccurs=“0”/>

<xs:element name=“bmFileRepair” type=“bmFileRepairType”

minOccurs=“0”/>

<xs:element name=“postReceptionReport” type=“reportProcedureType”

minOccurs=“0”/>

<xs:element ref=“r12:consumptionReport” minOccurs=“0”/>
<xs:element ref=“sv:schemaVersion”/>
<xs:any namespace=“##other” processContents=“skip” minOccurs=“0”

maxOccurs=“unbounded”/>

</xs:sequence>

</xs:complexType>
<xs:complexType name=“basicProcedureType”>

<xs:sequence>

<xs:element name=“serviceURI” type=“xs:anyURI”

maxOccurs=“unbounded”/>

</xs:sequence>
<xs:attribute name=“offsetTime” type=“xs:unsignedLong” use=“optional”/>
<xs:attribute name=“randomTimePeriod” type=“xs:unsignedLong”

use=“required”/>

</xs:complexType>
<xs:complexType name=“bmFileRepairType”>

<xs:attribute name=“sessionDescriptionURI” type=“xs:anyURI”

use=“required”/>

</xs:complexType>
<xs:complexType name=“reportProcedureType”>

<xs:complexContent>

<xs:extension base=“basicProcedureType”>

<xs:attribute name=“samplePercentage” type=“xs:decimal”

use=“optional”

default=“100”/>

<xs:attribute name=“forceTimeIndependence” type=“xs:boolean”

use=“optional”

default=“false”/>

<xs:attribute name=“reportType” use=“optional”default=“RAck”>

<xs:simpleType>

<xs:union memberTypes=“knownReportType xs:string”/>

</xs:simpleType>

</xs:attribute>
<xs:attribute name=“integratedDashOverMbmsReporting”

type=“xs:boolean” use=“optional” default=“false”>

</xs:extension>

</xs:complexContent>

</xs:complexType>
<xs:simpleType name=“knownReportType”>

<xs:restriction base=“xs:string”>

<xs:enumeration value=“RAck”/>
<xs:enumeration value=“StaR”/>
<xs:enumeration value=“StaR-all”/>
<xs:enumeration value=“StaR-only”/>

</xs:restriction>

</xs:simpleType>

</xs:schema>

When a wireless device receives the ADPD, with the added attribute, e.g. an integrated DashOverMbmsReporting attribute, enabled, the wireless device will coordinate its QoE reporting with its DASH QoE reporting accordingly. Under such circumstances, any configuration in DASH Media Presentation Description (MPD), relevant for DASH QoE reporting will be overridden by configurations from the ADPD, relevant for MBMS QoE. In other words, while the actual metrics to be reported in the MBMS QoE report will be maintained, any DASH MPD related instructions on how to report will not be maintained or considered in case coordinated QoE reporting has been requested. In a corresponding way, any type of description, applicable for any other non-MBMS client, will be overridden. It is to be understood that instead of providing the request in an ADPD, an indication, such as e.g. a flag, parameter, or any other type of indicator, may be provided in a suitable message, which is interpretable by the wireless device.

FIG. 3 is another signaling scheme, illustrating how coordination between a MBMS client and a DASH client of a wireless device can be achieved after the wireless device has received the enabled attribute, e.g. as described above, with reference to FIG. 2.

In a first step 3:10, the MBMS client 300 executes a random selection decision, for determining whether to report and to further determining which server, from a list of available servers, to report QoE reports to. The actual random selection procedure is executed according to standard procedures, and will therefore not be described in further detail in this document. Sub-section 9.4.3 of 3GPP TS 26.346 R13 v13.1.0 specifies how a wireless device determines whether to report based on a samplePercentage attribute, while sub-section 9.4.5 of the same spec. specifies how a reception report server is selected based on a list of servers. In a next step 3:20, a coordinated QoE reporting configuration message is put together by the MBMS client 300. Such a configuration will comprise information needed for the DASH client 310 to enable coordination of its QoE reporting to the server determined in step 3:10. More specifically, the configuration will comprise an indication of the derived decision on whether or not the MBMS client 300 will report QoE, here represented by the Boolean parameter, referred to as “Report” in the configuration message, as well as an indication of the selected server, here reported as “Server” parameter.

The configuration message also comprise the client identity, here referred to as “Client ID”, typically represented by the relevant Mobile Station International Subscriber Directory Number (MSISDN), and the device identity, referred to as “device ID”, typically represented by the relevant International Mobile Station Equipment Identity (IMEI). In addition, the sample percentage, used by the MBMS client 300 for determining whether or not to report QoE, is provided to the DASH client 310. Thereby, the DASH client 310 will know which server to report to and it will be able to report with the same client ID and device ID as the MBMS client 300 is using. In addition, the DASH client 310 will be able to consider the sample percentage of the MBMS client 300, when determining if it shall report QoE or not, in a way which will be described in further detail below. In another step 3:30, the DASH client 310 confirm reception of the coordinated reporting configuration from the MBMS client 300. In a subsequent step 3:40, the DASH client 310 determines, based on content of the coordinated reporting configuration, whether or not to provide QoE report or not.

As already implied above, both the MBMS client 300 and the DASH client 310 will have a separate sample percentage configured, but applicable on different protocol layers. If the sample percentage applicable for the MBMS client 300, received by the DASH client 310 in step 3:20, exceeds the sample percentage applicable for the DASH client 310, the DASH client shall follow the “Report” decision of the configuration received in step 3:20 unconditionally, i.e. without considering its own sample percentage. By way of example, in case the DASH sample percentage, provided to the wireless device in an MPD, is 20%, while the MBMS sample percentage, provided to the wireless device in an ADPD is 30%, both clients will apply the MBMS sample percentage 30%.

However, in case the sample percentage applicable for the DASH client exceeds the MBMS applicable sample percentage, the DASH client will rely on the difference between the two sample percentage parameters, i.e.

DASH sample percentage—MBMS sample percentage is the sample percentage which will be used by the DASH client as an input to the random number generator of the DASH client to decide whether to report QoE or not, even if the MBMS client has decided not to report. If e.g. the DASH sample percentage is 50%, while the MBMS sample percentage is 30%, coordinated reporting will be applied at 30%, while remaining 20% will be available for unicast reporting from the DASH client, i.e. for reporting from the DASH client when the MBMS reception is not active.

As indicated in the signaling scheme of FIG. 4, the process described above with reference to FIG. 3 may alternatively be initiated by the DASH client 310, i.e. the DASH client 310 requests a coordinated reporting configuration from the MBMS client 300, as indicated in step 4:10. Here such a request is denoted as “GET coordinated reporting configuration”. A typical use case is when a DASH QoE report is configured to report ongoing service consumption periodically while MBMS QoE report is configured to provide later aggregated reporting after service consumption has finished.

Such a request will trigger the MBMS client 300 to perform a random selection decision, in order to derive decisions and parameters necessary for assembling the requested configuration, as indicated in a next step 4:20. Once a server for transmitting QoE reports to has been selected and the reporting decision has been made by the MBMS client 300, the MBMS client 300 generates a response, here referred to as “GET coordinated reporting configuration response”, comprising the same parameters as described above, with reference to FIG. 3. In accordance with FIG. 3, the DASH client 310 also responds to a successful reception of the response of step 4:30 with a confirmation message, here referred to as “GET coordinated reporting configuration response confirmation”, as indicated in a step 4:40.

Since the DASH MPD specification according to ISO/IEC 23009-1:2014(E), Amd 1, Amd 2, does neither support use of any deviceID attribute, nor any random selection of a server, the MPD needs to be extended also for this purpose if a DASH client is to apply the suggested procedure. The former can be achieved by including the deviceID attribute, underlined in the following MPD:

<?xml version=“1.0”?>
<xs:schema xmlns:xs=“http://www.w3.org/2001/XMLSchema”

targetNamespace=“urn:3gpp:metadata:2011:HSD:receptionreport”
xmlns=“urn:3gpp:metadata:2011:HSD:receptionreport”

elementFormDefault=“qualified”>

<xs:element name=“ReceptionReport” type=“ReceptionReportType”/>
<xs:complexType name=“ReceptionReportType”>

<xs:choice>

<xs:element name=“QoeReport” type=“QoeReportType” minOccurs=“0”

maxOccurs=“unbounded”/>

<xs:any namespace=“##other” processContents=“skip” minOccurs=“0”

maxOccurs=“unbounded”/>

</xs:choice>
<xs:attribute name=“contentURI” type=“xs:anyURI” use=“required”/>
<xs:attribute name=“clientID” type=“xs:string” use=“optional”/>

<xs:attribute name=“deviceID” type=“xs:string” use=“optional”/>

</xs:complexType>
<xs:complexType name=“QoeReportType”>

<xs:sequence>

<xs:element name=“QoeMetric” type=“QoeMetricType” minOccurs=“1”

maxOccurs=“unbounded”/>

<xs:any namespace=“##other” processContents=“skip” minOccurs=“0”

maxOccurs=“unbounded”/>

</xs:sequence>
<xs:attribute name=“periodID” type=“xs:string” use=“required”/>
<xs:attribute name=“reportTime” type=“xs:dateTime” use=“required”/>
<xs:attribute name=“reportPeriod” type=“xs:unsignedInt” use=“required”/>
<xs:anyAttribute processContents=“skip”/>

</xs:complexType>
<xs:complexType name=“QoeMetricType”>

<xs:choice>

<xs:element name=“HttpList” type=“HttpListType”/>
<xs:element name=“RepSwitchList” type=“RepSwitchListType”/>
<xs:element name=“AvgThroughput” type=“AvgThroughputType”

maxOccurs=“unbounded”/>

<xs:element name=“InitialPlayoutDelay” type=“xs:unsignedInt”/>
<xs:element name=“BufferLevel” type=“BufferLevelType”/>
<xs:element name=“PlayList” type=“PlayListType”/>
<xs:element name=“MPDInformation” type=“MpdInformationType”

```
  </xs:restriction>
  </xs:simpleType>
  <xs:complexType name=“BufferLevelType”>
```

<xs:choice>

<xs:element name=“BufferLevelEntry” type=“BufferLevelEntryType”

maxOccurs=“unbounded”/>

</xs:choice>

<xs:anyAttribute processContents=“skip”/>

```
  </xs:complexType>
  <xs:complexType name=“BufferLevelEntryType”>
```

```
  <xs:attribute name=“t” type=“xs:dateTime” use=“required”/>
  <xs:attribute name=“level” type=“xs:unsignedInt” use=“required”/>
  <xs:anyAttribute processContents=“skip”/>
```

```
  </xs:complexType>
  <xs:complexType name=“PlayListType”>
```

<xs:choice>

<xs:element name=“Trace” type=“PlayListEntryType”

maxOccurs=“unbounded”/>

```
  </xs:choice>
  <xs:anyAttribute processContents=“skip”/>
```

```
  </xs:complexType>
  <xs:complexType name=“PlayListEntryType”>
```

<xs:choice>

<xs:element name=“TraceEntry” type=“PlayListTraceEntryType”

maxOccurs=“unbounded”/>

```
  </xs:choice>
  <xs:attribute name=“start” type=“xs:dateTime” use=“required”/>
  <xs:attribute name=“mstart” type=“xs:unsignedInt” use=“required”/>
  <xs:attribute name=“startType” type=“StartType” use=“required”/>
  <xs:anyAttribute processContents=“skip”/>
```

```
  </xs:complexType>
  <xs:complexType name=“PlayListTraceEntryType”>
```

```
  <xs:attribute name=“representationId” type=“xs:string” use=“optional”/>
  <xs:attribute name=“subrepLevel” type=“xs:unsignedInt” use=“optional”/>
  <xs:attribute name=“start” type=“xs:dateTime” use=“required”/>
  <xs:attribute name=“mstart” type=“xs:unsignedInt” use=“required”/>
  <xs:attribute name=“duration” type=“xs:unsignedInt” use=“required”/>
  <xs:attribute name=“playbackSpeed” type=“xs:double” use=“optional”/>
  <xs:attribute name=“stopReason” type=“StopReasonType”
```

use=“optional”/>

<xs:attribute name=“stopReasonOther” type=“xs:string” use=“optional”/>

<xs:anyAttribute processContents=“skip”/>

</xs:complexType>
<xs:simpleType name=“StartType”>

<xs:restriction base=“xs:string”>

<xs:enumeration value=“NewPlayoutRequest”/>
<xs:enumeration value=“Resume”/>
<xs:enumeration value=“OtherUserRequest”/>
<xs:enumeration value=“StartOfMetricsCollectionPeriod”/>

</xs:restriction>

</xs:simpleType>
<xs:simpleType name=“StopReasonType”>

<xs:restriction base=“xs:string”>

<xs:enumeration value=“RepresentationSwitch”/>
<xs:enumeration value=“Rebuffering”/>
<xs:enumeration value=“UserRequest”/>
<xs:enumeration value=“EndOfPeriod”/>
<xs:enumeration value=“EndOfContent”/>
<xs:enumeration value=“EndOfMetricsCollectionPeriod”/>
<xs:enumeration value=“Failure”/>

<xs:enumeration value=“Other”/>

</xs:restriction>

</xs:simpleType>
<xs:complexType name=“MpdInformationType”>

<xs:choice>

<xs:element name=“Mpdinfo” type=“RepresentationType”

maxOccurs=“unbounded”/>

</xs:choice>
<xs:attribute name=“representationId” type=“xs:string” use=“required”/>
<xs:attribute name=“subrepLevel” type=“xs:unsignedInt” use=“optional”/>
<xs:anyAttribute processContents=“skip”/>

</xs:complexType>
<xs:complexType name=“RepresentationType”>

```
<xs:attribute name=“codecs” type=“xs:string” use=“required”/>
<xs:attribute name=“bandwidth” type=“xs:unsignedInt” use=“required”/>
<xs:attribute name=“qualityRanking” type=“xs:unsignedInt” use=“optional”/>
<xs:attribute name=“frameRate” type=“xs:double” use=“optional”/>
<xs:attribute name=“width” type=“xs:unsignedInt” use=“optional”/>
<xs:attribute name=“height” type=“xs:unsignedInt” use=“optional”/>
<xs:attribute name=“mimeType” type=“xs:string” use=“required”/>
  <xs:anyAttribute processContents=“skip”/>
  </xs:complexType>
  <xs:simpleType name=“DoubleVectorType”>
```

<xs:list itemType=“xs:double”/>

```
  </xs:simpleType>
  <xs:simpleType name=“StringVectorType”>
```

<xs:list itemType=“xs:string”/>

```
  </xs:simpleType>
  <xs:simpleType name=“UnsignedIntVectorType”>
```

<xs:list itemType=“xs:unsignedInt”/>

</xs:simpleType>

</xs:schema>

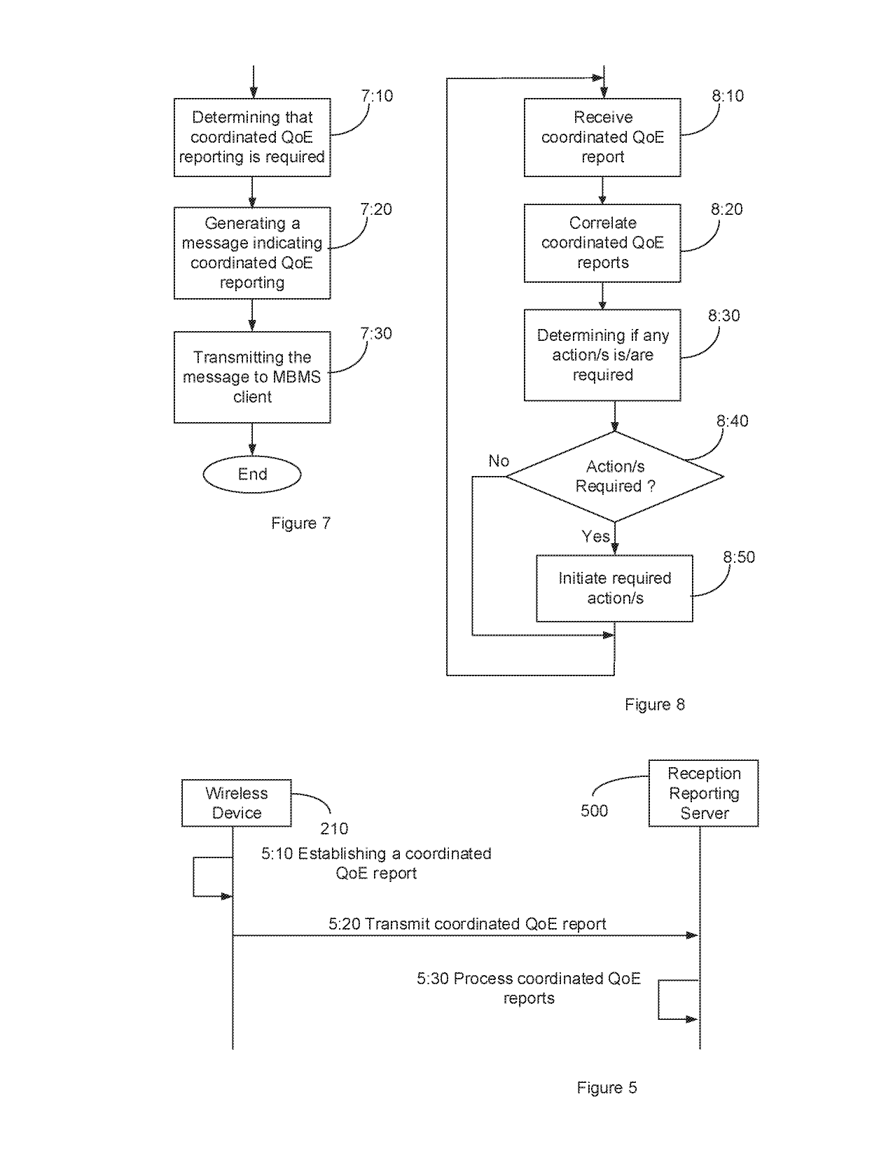

FIG. 5 is a signaling scheme, illustrating how a wireless device can interact with a network node, typically a server, or more specifically a reception reporting server 500 and provide coordinated QoE reports to the server. In a first step 5:10, a coordinated QoE report is established by a wireless device 210, as described above, and in a subsequent step 5:20, the report is transmitted to the server, so that, in a final step 5:30, the server can process the report directly or the received, QoE report data could be processed by a separate analytic server, together with other related reports, thereby enabling appropriate actions to be taken at the network, at least partly on the basis of the processed, coordinated reports.

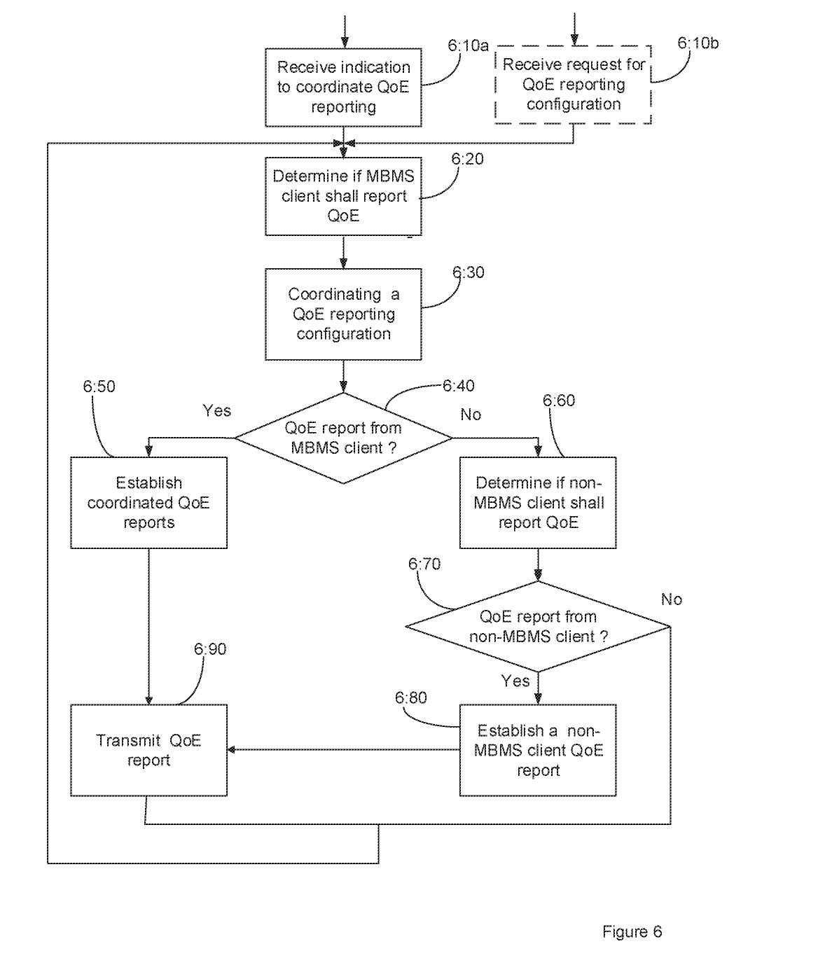

A method executable at a wireless device, having a MBMS client and a non-MBMS client, e.g. a DASH client or HLS client, and capable of applying coordinated QoE reporting will now be described in further detail below, with reference to FIG. 6

In a first step 6:10a, the wireless device receives an indication, indicating for the wireless device that coordinated QoE reporting is to be applied by it. This can be executed as suggested above, with reference to FIG. 2, or in any other possible way, e.g. by using a flag or any other type of indicator which the wireless device is capable of interpreting. As indicated in the figure, alternatively, the described process can be initiated from the non-MBMS client, as indicated with alternative step 6:10b. However, the latter step can normally only occur after a process initiated from the network, starting with step 6:10a has been executed.

In a next step 6:20, it is determined if the MBMS client shall report QoE reporting or not, based on sample percentage, as mentioned above. When the MBMS client has determined whether it will report or not and decided on which server to report to, it initiates a coordination, or execution, of a QoE reporting configuration for the non-MBMS client, as indicated with another step 6:30.

If, in subsequent step 6:40, it is determined that the MBMS client shall provide a QoE report, and this has been reported to the non-MBMS client, the non-MBMS client will establish a coordinated report as well, as indicated in step 6:50, and the coordinated QoE reports are then transmitted to the selected server, as indicated with step 6:90. Besides by any one of the clients to transmit an aggregated MBMS QoE report and non-MBMS QoE report, for example by using the multipart MIME format, it is to be understood that in case step 6:50 is executed, both clients will produce and transmit separate QoE reports, which are to be considered as coordinated, as has been described above, i.e. the reports are arranged so that they can later be correlated, based on one or more of the client ID, device ID and a timestamp, where a time stamp could be provided according to any prior art solution.

However, in case the MBMS client decides in step 6:40 not to report, it is in subsequent steps 6:60 and 6:70 determined if the non-MBMS client shall report or not, on the basis of the configuration provided from the MBMS client. If, in step 6:70, it is determined that the non-MBMS client is to report, a coordinated non-MBMS client QoE report is established, as indicated in step 6:80, and the report is transmitted to the server selected by the MBMS client, as indicated with step 6:90. If no report is to be transmitted by the non-MBMS client, the process is re-iterated from 6:20 as long as service consumption is still ongoing, after which the process will be terminated.

A method as executed in a network node, typically a BM-SC, or another network node, comprising corresponding broadcast delivery functionality, will now be described in further detail below, with reference to FIG. 7. In a first step 7:10, it is determined that coordinated QoE reporting is required from a specific wireless device. In a next step 7:20, the network node is generating a message, indicating a requirement for coordinated QoE reporting, e.g. in the form of an attribute in an extended ADPD, as already described herein, or a flag, parameter, or any other indicator which can be interpreted accordingly by the wireless device. In a final step 7:30, the message is transmitted to the wireless device, or more specifically, to one of the clients of the wireless device. Once the message, including the request for coordinated QoE reporting, has been sent to, and processed accordingly at the wireless device, subsequent QoE reports provided from the wireless device to the selected server will be provided as coordinated QoE reports, as described herein. It is to be understood, that even though the method described above is presented with respect to one wireless device, a typical scenario will disclose a plurality of parallel processes as described with reference to FIG. 7, when it is decided by the respective network node that a plurality of wireless devices shall be instructed to apply coordinated QoE reporting.

A method for handling coordinated QoE reporting provided from a number of wireless devices at a network node, will now be described in further detail with reference to FIG. 8.

Typically the network node executing the method as described with reference to FIG. 8 is a network node which is accessible by the server selected by the wireless devices as the server to report QoE to, and capable of processing and evaluating coordinated QoE reports. The mentioned network node may e.g. be a Business Intelligence Analytics node, but alternatively, it may be another network node which is capable of interpreting and make use of coordinated QoE reports as is described herein, or the network node may be the actual server receiving the report, which is also capable of processing and correlating the coordinated reports.

In a first step 8:10, coordinated QoE reporting is received and in a subsequent step 8:20, the content received in the coordinated QoE reporting is evaluated for determining if any adjustment to one or more parameters is required. If, in a step 8:30 it is determined that at least some adjustment is required, the appropriate adjustment is executed, as indicated in a next step 8:40, or else, the process is re-iterated from beginning. Normally the described process is repeated until it is terminated when the service consumption is no longer on-going.

It is here to be understood that, once use of coordinated QoE reporting has been requested from the network and initiated at a number of wireless devices, coordinated QoE reports will normally be received more or less continuously by the mentioned network node, so that a decision can be taken, e.g. when a threshold value is exceeded due to a sufficient number of reports, pointing in a certain direction. It is also to be understood that, by repeating the described process for a plurality of received reports, more data will be correlated, and, thus, a more representative result can be obtained from correlating coordinated QoE reports. Even though FIG. 8 is showing a process where correlation of received reports is executed each time a report is received, the process may alternatively be configured such that correlation is executed based on received and stored reports at pre-defined time intervals, scheduled for applicable batch processing.

Since the mentioned network node will be able to correlate received, coordinated QoE reports based on the common identities used in these reports, possibly in combination with time stamps, the different data provided from the different clients can be combined in different ways. In general, the output could be provided as analytics, based on time series, generating line charts, associated with an individual communication device; line charts of an individual cell of a specific MBMS service area, or line charts of a specific MBMS broadcast service. According to a first embodiment, from any of these line charts, trends or abnormal cases can be identified, either at a specific wireless device, within a specific cell of a specific broadcast area, or for a specific MBMS broadcast service.

According to another embodiment, scatter, or box plots could be drawn, or provided on the basis of received coordinated QoE reports, for analysis e.g. of user distribution on different broadcast services, or on different cells of MBMS service areas. Alternatively, the mentioned data could be used for analysis of user retention on a MBMS broadcast service, where low retention could result in further analysis e.g. on object data loss, re-buffering data and/or representation switch data. Below a plurality of non-exhaustive examples are given on how retrieved data may be used for making decisions.

From “Representation switch events” metrics provided in DASH QoE reports, one can get all switch events associated with an individual user and corresponding information on the time of these switch events, as well as the appropriate identities of DASH formatted content to switch to, as well as coordinated MBMS reports associated with the same users, i.e. having the same identities, so that, according to one example, it is possible to discern the representation switch events:
The switch at the time point when consumption of MBMS is started (from start time of MBMS QoE reporting), indicating a unicast to broadcast switch.
The switch at the time point when consumption of MBMS is stopped (from stop time of MBMS QoE reporting), indicating a broadcast to unicast switch.
Remaining switch events will be referred to as intra-unicast switching, based on client adaptive streaming.

According to another example, focusing instead on network service-specific problem identification, “Object Loss” metrics, provided from MBMS QoE Reports can provide object loss status of a wireless device when receiving DASH-formatted content through MBMS broadcasting. By correlating this type of information with DASH QoE related “HTTP Request/Response transaction” metrics and the “stop reason” attribute of the “Play list” metrics, one can obtain information on how DASH-formatted content is being consumed by the same users, and thereby one can be able to diagnose service specific problems correspondingly, e.g. according to the following table:

TABLE 1

| | DASH QoE metrics | |
|---|---|---|
| | (HTTP | |
| | Request/Respose | |
| MBMS QoE Metrics | transaction and “Play | Problem |
| (Object loss) | List” | Diagnosing |
| Object loss is very | ”play list” stop reason is | The UE firmware |
| high for few users | rebuffering and ”HTTP | have a problem or |
| (service level) | Request/Response code | the wireless device is |
| | is 404 not found (service | need to be correctly |
| | level) | configured (for |
| | | problem UE only) |
| Object loss is very | ”play list” stop reason is | Increase the FEC |
| high for majority of | rebuffering and ”HTTP | redundancy level or |
| users (service level) | Request/Response code | adjust the radio side |
| | is 404 not found (service | MCS configuration to |
| | level) | a more robust level |
| Almost no object loss | ”play list” stop reason is | The delay budget is |
| is identified | rebuffering and ”HTTP | insufficient. Update |
| | Request/Response code | the MPD |
| | is 404 not found (service | configuration for the |
| | level) | availabilityStartTime |
| | | to indicate client to |
| | | get segments at |
| | | delayed time |

Below, another example referring to Network service area-specific problem identification will be described in table 2. In this example, “network resource” metrics and “object loss” metrics, provided in MBMS QoE reports, gives a receiving status within a traversed cell list. If this information is combined with “Play List” metrics and HTTP Request/Response transaction” metrics, provided from DASH QoE reports, one can get indications on how DASH-formatted content is being consumed by the same user within the traversed cell list, and, based on this information, one will be able to diagnose service area specific problems, correspondingly, as indicated below.

TABLE 2

| | DASH QoE metrics | |
|---|---|---|
| | (HTTP | |
| | Request/Respose | |
| MBMS QoE Metrics | transaction and “Play | Problem |
| (Object loss) | List” | Diagnosing |
| Object loss is very | ”play list” stop reason is | ”play list” stop reason |
| high for few users | rebuffering and ”HTTP | is rebuffering and |
| (service area level) | Request/Response code | ”HTTP |
| | is 404 not found (service | Request/Response |
| | level) | code is 404 not found |
| | | (service level) |
| Object loss is very | Object loss is very high | Object loss is very |
| high for majority of | for majority of users | high for majority of |
| users (service area | (service area level) | users (service area |
| level) | | level) |
| Object loss is very | Object loss is very high | Object loss is very |
| high for majority of | for majority of users | high for majority of |
| users (service area | (service area level) | users (service area |
| level) | | level) |

In a third example, referring to network throughput/bandwidth problem identification, “network resource” metrics and “object loss” metrics, provided from MBMS QoE reports, can provide receiving status of a service for a wireless device. By correlating the mentioned information with “Average throughput” metrics and “activity time” and “inactivity type” attributes, provided in DASH QoE reports, one can get an indication if average throughput DASH-formatted content is being consumed by the same user, and if there is inactive time identified, the reason for inactivation, i.e. user pause or an error. One may also be able to diagnose the network bandwidth problem correspondingly, as indicated in table 3 below:

TABLE 3

| MBMS QoE Metrics | DASH QoE metrics | Problem |
|---|---|---|
| (Object loss) | (Average throughput) | Diagnosing |
| No object loss | ”Average throughput” << | The APP or player on |
| eMBMS session's | GBR and ”inactivity type” | the wireless device |
| GBR | under ”Average | have problem or the |
| | throughput” shows client | wireless device is not |
| | buffer instead of user | configured correctly |
| | pause | |
| Object loss | ”Average throughput” | Increase radio GBR |
| occasionally | ~GBR and ”inactivity | or decrease the |
| | type” under ”Average | broadcast content bit |
| eMBMS session's | throughput” shows error | rate to a lower |
| GBR | instead of user pause | representation at the |
| | | content ingestion |
| | | side |

A wireless device capable of providing coordinated QoE reporting as described above, will now be described in further detail below. More specifically, the wireless device comprises means for executing the method as described above with reference to FIG. 6.

The wireless device comprise means for receiving, a message from a first network node, where the message is indicating that QoE reporting from the MBMS client shall be coordinated with QoE reporting from the non-MBMS client; for enabling the MBMS client to determine whether or not the MBMS client is to establish coordinated QoE reports to the second network node; for coordinating a coordinated QoE reporting configuration between the MBMS client and the non-MBMS client, at least partly on the basis of the result of the preceding determining procedure; for enabling the non-MBMS client to determine, on the basis of content of said configuration, whether or not the non-MBMS client is to establish coordinated QoE reports to the second network node, and for transmitting any established, coordinated QoE report to the second network node.

More specifically, the wireless device comprises means for coordinating QoE reporting by coordinating a first set of metrics of a first protocol layer, measured by the MBMS client and a second set of metrics of a second protocol layer, measured by the non-MBMS client.

The wireless device comprises means for signalling a need for coordinated QoE reporting. According to one embodiment, means are adapted to provide a message signaled to the wireless device in an Associated Delivery Procedure Description (ADPD), comprising an indicator, indicating, either that coordinated QoE reporting is required, or that it is not required. In the latter situation, the wireless device is adapted to apply any type of conventional QoE reporting. Means of the wireless device may be configured so that, once indicated to the wireless device, coordinated QoE reporting is initiated either by the MBMS client, or the non-MBMS client.

Since the sample percentage applied by the MBMS client may differ from the one applied for the non-MBMS client, the wireless device typically also comprise means for handling such a situation in an efficient way, such that means are configured to determine, by the non-MBMS client, based on the difference between a sample percentage, applicable for the non-MBMS client and a sample percentage, applicable for the MBMS client, if the non-MBMS client is to transmit a non-MBMS dependent coordinated QoE report, in case it was determined by the MBMS client not to send a coordinated QoE report and in case the sample percentage applicable for the MBMS client is less than the sample percentage applicable for the non-MBMS client, and to establish, by the non-MBMS client, a non-MBMS client dependent coordinated QoE report and transmit the established report to the second network node, in case it was determined by the non-MBMS client to generate and transmit a non-MBMS dependent coordinated QoE report.

Means of the wireless device may also be configured so that, in case the sample percentage applicable for the MBMS client exceeds or is equal to the sample percentage applicable for the non-MBMS client, the determining processes, previously executed by the MBMS client and the non-MBMS client are executed by initiating a calculation by a respective random number generator on the basis of a sample percentage, applicable for the respective MBMS client.

The wireless device is also provided with means for executing coordination of the coordinated QoE reporting configuration by providing, from the MBMS client to the non-MBMS client, a client Identity and a device Identity, which identities are common for the MBMS client and the non-MBMS client, and which identities are included into the at least one coordinated QoE report transmitted by the wireless device.

The wireless device also comprise means for enabling the MBMS client, to determine the network node, or server, to which the coordinated QoE report is to be transmitted by the wireless device, based on a list of available network nodes, and for transmitting the coordinated QoE report to the determined second node. Thereby, the wireless device is capable of transmitting coordinated QoE reports originating from different clients of a wireless device to one and the same network node/server for more efficient processing.

The wireless device, may be any type of MBMS enabled portable or fixed mounted device, which may also be referred to as mobile communication terminal, user equipment, mobile terminal, machine-to-machine (M2M) device, and may e.g. be a mobile phone, or a tablet/laptop with wireless connectivity.

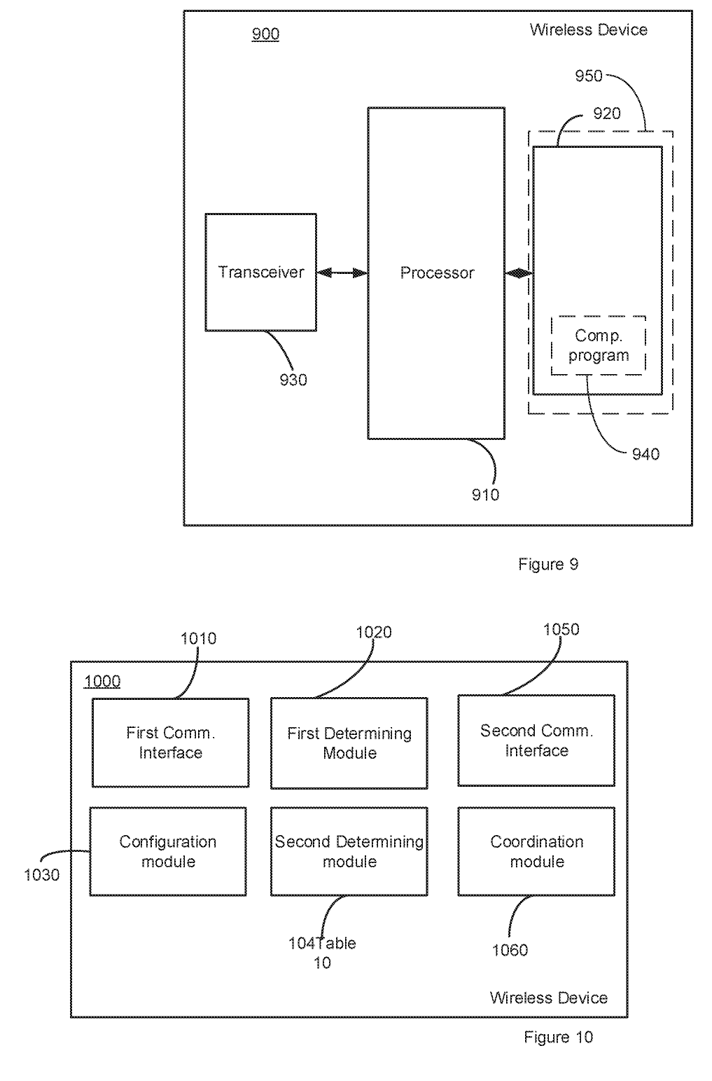

According to one embodiment, the wireless device is arranged as illustrated in FIG. 9, where the wireless device 900, comprise a processor 910 and a memory 920, comprising executable instructions, which when executed by the processor 910 causes the wireless device 900 to perform a method as described above, with reference to FIG. 6 and as disclosed above. The executable instructions are typically provided as a computer program 940, stored at the memory 920. The wireless device is capable of communicating with network nodes via at least one transceiver 930. At least parts of the memory 920, comprising at least parts of the computer program 940, may be provided as a computer program product 950, which may be arranged as any combination of e.g. Random Access Memory (RAM), Read Only Memory (ROM), Flash memory, magnetic tape, Compact Disc (CD) ROM, Digital Versatile Disc (DVD), and Blue-Ray disc.

According to another embodiment, which is illustrated in FIG. 10, a wireless device is comprising a plurality of functional modules or units and interfaces, where a first communication interface 1010 is configured to receive a message, indicating a request for coordinated QoE reporting, whereas a first determining module 1020 is configured to determine whether the MBMS client is to establish a coordinated reporting, while a configuration module 1030 is configured to coordinate QoE reporting configuration, at least partly on the basis of the result from the first determining module, while a second determining module 1040 is configured to determine, considering the configuration, whether the non-MBMS client is to establish coordinated QoE reporting. A coordination module 1060 is configured to coordinate QoE reports, when applicable, based on the process as described above, while a second communication interface 1050 is configured to transmit any coordinated QoE reports. The mentioned modules may further be configured to also execute any of the processes as described above.

A network node, such as e.g. a BM-SC, or any other network node, capable of providing corresponding functionality, and capable of instructing a wireless device to apply coordinated QoE reporting will now be described in further detail below. Such a network node is provided with means for requesting QoE reporting from a wireless device, as described above, wherein means are configured to determine that a QoE report that is coordinated between the two clients is required; to generate a message comprising an indicator, indicating the requirement of the coordinated QoE reporting, and to transmit the generated message to the wireless device. According to one embodiment, the network node comprises means for providing the message to the wireless device in an ADPD, comprising an indicator, indicating a request for coordinated QoE reporting.

According to one embodiment a network node 1100 comprises a processor 1110 and a memory 1120, where the memory 1120 comprises instructions which when executed by the processor 1110 causes the network node to execute a process according to the method as described above, with reference to FIG. 7. The network node is configured to communicate with wireless devices via a communication interface 1130.

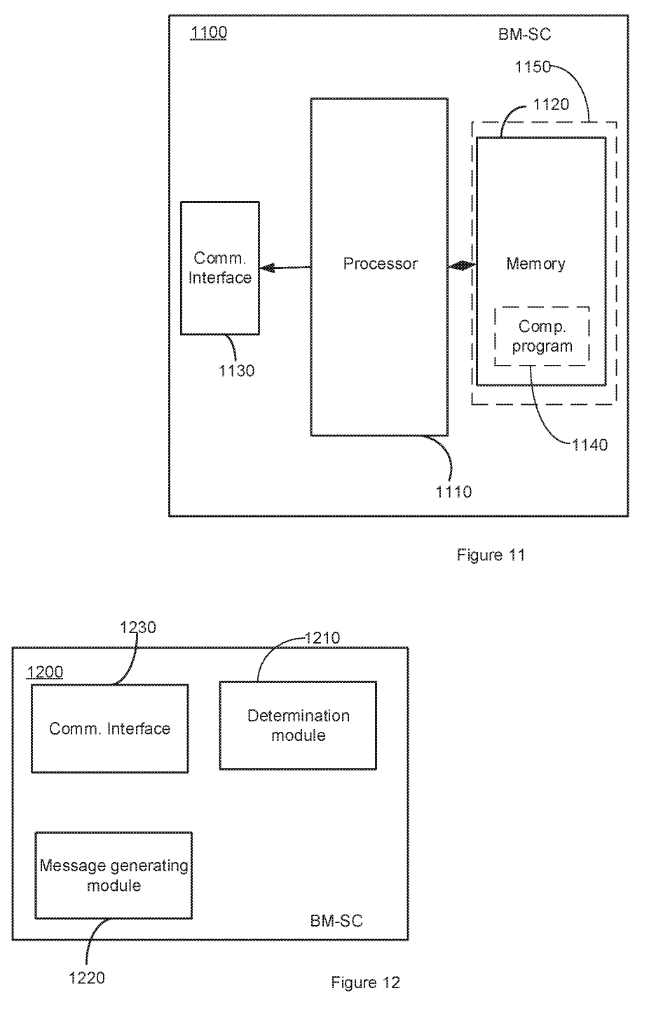

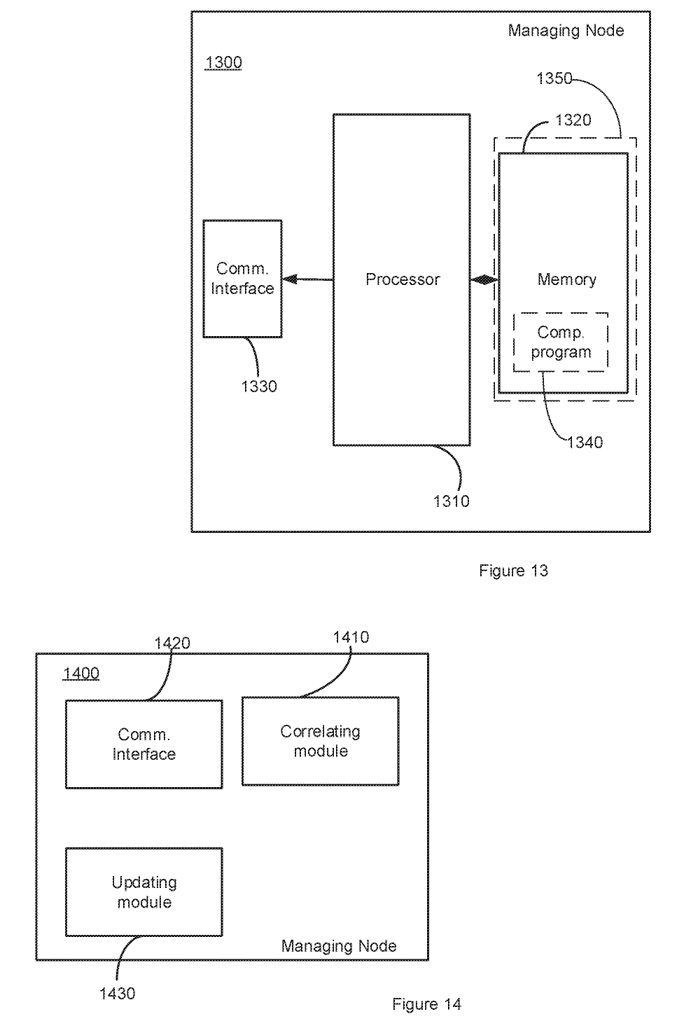

According to another embodiment, a network node 1200 comprises a plurality of modules or units, and an interface, as illustrated in FIG. 12. More specifically, a determining module 1210 is configured to determine that coordinated QoE reporting is required from a wireless device, after which a message generating module 1220 is configured to generate a message, indicating the required coordinated QoE reporting, while a communication interface 1230 is capable of transmitting the generated message to the respective wireless device. As already mentioned above, the described procedure is typically repeated for a plurality of wireless devices. The message generating module 1220 may be configured to provide the mentioned message in an ADPD, or any other suitable means of transportation.

Another network node, capable of making use of coordinated QoE reports which have been received from wireless devices, will now be described in further detail below. Such a network node may be e.g. a managing node, or any other type of network node, which is capable of recognizing and processing coordinated QoE reports as suggested below.

The network node comprises means for receiving coordinated QoE reports from wireless devices, for correlating received, coordinated QoE reports and for determining, on the basis of the correlating, if one or more actions is/are required for improving the performance of the MBMS related services for which QoE reporting has been provided. The means for correlating coordinated QoE reports is configured so that the correlation can be based at least on a device identity.

According to one embodiment, the network node 1300 comprises at least one processor 1310, and a memory 1320, comprising instructions, which when executed by the processor 1310 causes the network node 1300 to perform a method according to FIG. 8. The network node 1300 is configured to communicate with wireless devices, or a server, receiving coordinated QoE reports from wireless devices, via a communication interface 1330.

According to another embodiment, the network node 1400 instead comprise a number of modules or units and interface, where a correlation module 1410 is configured to execute the mentioned correlations on coordinated QoE reports, received via a communication interface 1420, and an updating module 1430 is configured to update relevant functions and/or processes of the network, based on the outcome of the correlation.

Each of the wireless device 900 and the two network nodes 1100,1300 mentioned above may each comprise at least one respective computer program product (CPP) 950, 1150, 1350, in the form of a non-volatile memory, e.g. a flash memory, a disc drive, a RAM (Random-access memory) ROM (Read-Only Memory) or an EEPROM (Electrically Erasable Programmable Read-Only Memory), where the CPP 950, 1150, 1350 is capable of carrying a respective computer program 940, 1140, 1340.

Each of the processors mentioned above may be arranged as a single CPU (Central processing unit), but could also comprise two or more processing units. For example, a processor may include one or more general purpose microprocessors; instruction set processors and/or related chips sets and/or special purpose microprocessors, such as ASICs (Application Specific Integrated Circuit). The processors may also comprise board memory for caching purposes.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

1. A method in a wireless device, comprising a MBMS client and a non-MBMS client, for reporting QoE from the wireless device to a second network node of a wireless network, the method comprising:
Receiving (6:10a), from a first network node, a message indicating that QoE reporting from the MBMS client shall be coordinated with QoE reporting from the non-MBMS client;
Determining (6:20), by the MBMS client, whether or not the MBMS client is to establish coordinated QoE reports to the second network node;
Coordinating (6:30), between the MBMS client and the non-MBMS client, a coordinated QoE reporting configuration, at least partly on the basis of the result of said determining, and
Determining (6:60), by the non-MBMS client, on the basis of content of said configuration, whether or not the non-MBMS client is to establish coordinated QoE reports to the second network node, and
Transmitting (6:90) any established, coordinated QoE report to the second network node.

2. The method according to claim 1, wherein coordination of QoE reporting comprises coordination of a first set of metrics of a first protocol layer, measured by the MBMS client and second set of metrics of a second protocol layer, measured by the non-MBMS client.

3. The method according to claim 1 or 2, wherein the message is provided to the wireless device in an Associated Delivery Procedure Description (ADPD), comprising an indicator, indicating that coordinated QoE reporting is required.

4. The method according to any of claims 1-3, wherein the coordination (6:30) of the coordinated QoE reporting configuration is initiated by the MBMS client.

5. The method according to claim 1-3, wherein the coordination (6:30) of the coordinated QoE reporting configuration is initiated by the non-MBMS client.

6. The method according to any of claims 1-5 comprising the further steps of:
Determining (6:60;6:70), by the non-MBMS client, based on the difference between a sample percentage, applicable for the non-MBMS client and a sample percentage, applicable for the MBMS client, if the non-MBMS client is to transmit a non-MBMS dependent coordinated QoE report, in case it was determined by the MBMS client not to send a coordinated QoE report and in case the sample percentage applicable for the MBMS client<the sample percentage applicable for the non-MBMS client, and
Establishing(6:80), by the non-MBMS client, a non-MBMS client dependent coordinated QoE report and transmitting (6:90) the established report to the second network node, in case it was determined by the non-MBMS client to transmit a non-MBMS dependent coordinated QoE report.

7. The method according to any of claims 1-6, comprising the further steps of:
Determining, by the MBMS client, based on a list of available network nodes, the second network node to which the coordinated QoE report is to be transmitted by the non-MBMS client, and
Transmitting (6:90), by the non-MBMS client, the coordinated QoE report to the determined second node.

8. The method according to any of claims 1-7, wherein in case the sample percentage applicable for the MBMS client is>=the sample percentage applicable for the non-MBMS client, the determining, executed by the MBMS client and the non-MBMS client are executed by initiating a calculation by a respective random number generator on the basis of a sample percentage, applicable for the respective client.

9. The method according to any of claims 1-8, wherein the coordinating (6:30) of the coordinated QoE reporting configuration comprise providing, from the MBMS client to the non-MBMS client, a client Identity and a device Identity, which Identities are common for the MBMS client and the non-MBMS client, and which Identities are included into the coordinated QoE report transmitted by the wireless device.

10. A computer program (940) for a wireless device (900,1000), comprising a MBMS client and a non-MBMS client, for reporting QoE from the wireless device to a second network node of a wireless network, the computer program (940) comprising computer program code, which, when executed by at least one processor of the wireless device (900,1000) causes the wireless device (900,1000) to perform the method according to any of claims 1-9.

11. A computer program product (950), comprising a computer program (940) according to claim 10 and a computer readable means on which the computer program (940) is stored.

12. A wireless device (900,1000), comprising a MBMS client and a non-MBMS client, for reporting QoE from the wireless device (900,1000) to a second network node of a wireless network, the wireless device (900,1000) comprising means for:
Receiving, from a first network node (1100,1200), a message indicating that QoE reporting from the MBMS client shall be coordinated with QoE reporting from the non-MBMS client;
Determining, by the MBMS client, whether or not the MBMS client is to establish coordinated QoE reports to the second network node;
Coordinating, between the MBMS client and the non-MBMS client, a coordinated QoE reporting configuration, at least partly on the basis of the result of said determining;
Determining, by the non-MBMS client, on the basis of content of said configuration, whether or not the non-MBMS client is to establish coordinated QoE reports to the second network node, and
Transmitting any established, coordinated QoE report to the second network node.

13. The wireless device (900,1000) according to claim 12, further comprising means for coordinating QoE reporting by coordinating a first set of metrics of a first protocol layer, measured by the MBMS client and a second set of metrics of a second protocol layer, measured by the non-MBMS client.

14. The wireless device (900,1000) according to claim 12 or 13, further comprising means for providing the message to the wireless device in an Associated Delivery Procedure Description (ADPD), comprising an indicator, indicating that coordinated QoE reporting is required.

15. The wireless device (900,1000) according to any of claims 12-14, further comprising means for initiating the coordinating of the coordinated QoE reporting configuration by the MBMS client.

16. The wireless device (900,1000) according to any of claims 12-15, further comprising means for initiating the coordinating of the coordinated QoE reporting configuration by the non-MBMS client.

17. The wireless device (900,1000) according to any of claims 12-16 further comprising means for:
Determining, by the non-MBMS client, based on the difference between a sample percentage, applicable for the non-MBMS client and a sample percentage, applicable for the MBMS client, if the non-MBMS client is to transmit a non-MBMS dependent coordinated QoE report, in case it was determined by the MBMS client not to send a coordinated QoE report and in case the sample percentage applicable for the MBMS client<the sample percentage applicable for the non-MBMS client, and
Establishing, by the non-MBMS client, a non-MBMS client dependent coordinated QoE report and transmitting (6:90) the established report to the second network node, in case it was determined by the non-MBMS client to transmit a non-MBMS dependent coordinated QoE report.

18. The wireless device (900,1000) according to any of claims 12-17, (900,1000) further comprising means for:
Determining, by the MBMS client, based on a list of available network nodes, the second network node to which the coordinated QoE report is to be transmitted by the non-MBMS client, and
Transmitting, by the non-MBMS client, the coordinated QoE report to the determined second node.

19. The wireless device (900,1000) according to any of claims 12-18, further comprising means for, in case the sample percentage applicable for the MBMS client is>=the sample percentage applicable for the non-MBMS client, the determining, executed by the MBMS client and the non-MBMS client are executed by initiating a calculation by a respective random number generator on the basis of a sample percentage, applicable for the respective MBMS client.

20. The wireless device (900,1000) according to any of claims 12-19, further comprising means for executing the coordination of the coordinated QoE reporting configuration by providing, from the MBMS client to the non-MBMS client, a client Identity and a device Identity, which Identities are common for the MBMS client and the non-MBMS client, and which Identities are included into the coordinated QoE report transmitted by the wireless device.

21. A wireless device (900), comprising a MBMS client and a non-MBMS client, for reporting QoE from the wireless device (900) to a second network node of a wireless network, the wireless device (900) further comprising a processor (910) and a memory (920), said memory (920) comprising instructions which when executed by the processor (910) causes the wireless device (900) to:
Receive, from a first network node (1100,1200), a message indicating that QoE reporting from the MBMS client shall be coordinated with QoE reporting from the non-MBMS client;
Determine, by the MBMS client, whether or not the MBMS client is to establish coordinated QoE reports to the second network node;
Coordinate, between the MBMS client and the non-MBMS client, a coordinated QoE reporting configuration, at least partly on the basis of the result of said determining, and
Determine, by the non-MBMS client, on the basis of content of said configuration, whether or not the non-MBMS client is to establish coordinated QoE reports to the second network node, and
Transmit any established, coordinated QoE report to the second network node.

22. A method in a network node for requesting QoE reporting from a wireless device, comprising a MBMS client and a non-MBMS client, the method comprising:
Determining (7:10) that a QoE report that is coordinated between the two clients is required;
Generating (7:20) a message comprising an indicator, indicating the requirement of the coordinated QoE reporting, and
Transmitting (7:30) the generated message to the wireless device.

23. The method according to claim 22, wherein the message is provided to the wireless device in an Associated Delivery Procedure Description (ADPD), comprising an indicator, indicating a request for coordinated QoE reporting.

24. A computer program (1140) for a network node (1100,1200), comprising a MBMS client and a non-MBMS client, for reporting QoE from the wireless device to a second network node of a wireless network, the computer program (1140) comprising computer program code, which, when executed by at least one processor of the network node (1100,1200) causes the network node (1100,1200) to perform the method according to any of claim 22 or 23.

25. A computer program product (1150), comprising a computer program (1140) according to claim 24 and a computer readable means on which the computer program (1140) is stored.

26. A network node (1100, 1200) for requesting QoE reporting from a wireless device (900,1000), comprising a MBMS client and a non-MBMS client, the network node (1100, 1200) comprising means for:
Determining that QoE reports that are coordinated between the two clients is required;
Generating a message comprising an indicator, indicating the requirement of the coordinated QoE reporting, and
Transmitting the generated message to the wireless device.

27. The network node (1100, 1200) according to claim 26, further comprising means for providing the message to the wireless device in an Associated Delivery Procedure Description (ADPD), comprising an indicator, indicating a request for coordinated QoE reporting.

28. A network node (1100) for requesting QoE reporting from a wireless device (900,1000), comprising a MBMS client and a non-MBMS client, the network node (1100) comprising a processor (1110) and a memory (1120), said memory (1120) comprising instructions which when executed by the processor (1110) causes the network node (1100) to:
Determine that QoE reports that are coordinated between the two clients is required;
Generate a message comprising an indicator, indicating the requirement of the coordinated QoE reporting, and
Transmit the generated message to the wireless device.

29. A method in a network node of a wireless network for processing content of QoE reports reported from wireless devices, each comprising a MBMS client and a non-MBMS client, the method comprising:
Receiving (8:10), from one of said wireless devices, at least one coordinated QoE report;
Correlating (8:20) the at least one received coordinated QoE report with previously received coordinated QoE reports;
Determining (8:30;8:40), on the basis of said correlating, if at least one action is required by the network node, and
Initiating (8:50) said at least one action, in case it is determined that this is required.

30. The method according to claim 29, wherein the correlation of the QoE reports is based on a device Identity, identifying the wireless device, and being commonly used by the MBMS client and the non-MBMS client of the wireless device in the coordinated QoE reports.

31. A computer program (1340) for a network node (1300,1400), comprising a MBMS client and a non-MBMS client, for reporting QoE from the wireless device to a second network node of a wireless network, the computer program (1340) comprising computer program code, which, when executed by at least one processor of the network node (1300,1400) causes the network node (1300,1400) to perform the method according to any of claim 29 or 30.

32. A computer program product (1350), comprising a computer program (1340) according to claim 31 and a computer readable means on which the computer program (1340) is stored.

33. A network node (1300,1400) of a wireless network for processing content of QoE reports reported from wireless devices (900,1000), each comprising a MBMS client and a non-MBMS client, the network node (1300,1400) comprising means for:
Receiving, from one of said wireless devices, at least one coordinated QoE report;
Correlating the at least one received coordinated QoE report with previously received coordinated QoE reports;
Determining, on the basis of said correlating, if at least one action is required by the network node, and
Initiating said at least one action, in case it is determined that this is required.

34. The network node (1300,1400) according to claim 33, further comprising means for correlating the QoE reports based on a device Identity, identifying one of the wireless devices (900,1000), and being commonly used by the MBMS client and the non-MBMS client of the respective wireless device (900,1000) in the coordinated QoE reports.

35. A network node (1300) of a wireless network for processing content of QoE reports reported from wireless devices (900,1000), each of which is comprising a MBMS client and a non-MBMS client, the network node (1300) comprising a processor (1310) and a memory (1320), said memory (1320) comprising instructions which when executed by the processor (1310) causes the network node (1300) to:
Receive, from one of said wireless devices, at least one coordinated QoE report;
Correlate the at least one received coordinated QoE report with previously received coordinated QoE reports;
Determine, on the basis of said correlating, if at least one action is required by the network node, and
Initiate said at least one action, in case it is determined that this is required.
